(19) United States
(12) Patent Application Publication
(10) Pub. No.: US 2012/0105322 A1
(43) Pub. Date: May 3, 2012

(54) DRAWING DEVICE AND DRAWING METHOD

(75) Inventor: Kensuke OKANO, Kawasaki (JP)

(73) Assignee: Fujitsu Limited, Kawasaki (JP)

(21) Appl. No.: 13/341,371

(22) Filed: Dec. 30, 2011

Related U.S. Application Data
(63) Continuation of application No. PCT/JP2009/061917, filed on Jun. 30, 2009.

(51) Int. Cl. G06F 3/033

(52) U.S. Cl. 345/157

(57) ABSTRACT

A drawing device includes a pointer control section detecting each of operations performed by using a first pointer and a second pointer in a drawing region; a first generating section generating first drawing data that corresponds to a first drawing function specified for the first pointer and an operation performed in the drawing region by using the first pointer; a second generating section generating second drawing data that corresponds to a second drawing function specified for the second pointer and an operation performed in the drawing region by using the second pointer; and a drawing section generating drawing data obtained by combining the first drawing data and the second drawing data. With this, operability in the drawing is enhanced.

### CROSS-REFERENCE TO RELATED APPLICATION

This is a continuation of Application, filed under 35 U.S.C. §111(a) of International Application PCT/JP2009/061917, filed on Jun. 30, 2009, the contents of which are herein wholly incorporated by reference.

### FIELD

The disclosures made herein relate to a drawing technology.

### BACKGROUND

Currently, drawing applications having various drawing functions are available. With such drawing applications, it is possible to select a desired drawing mode such as a pencil mode, a brush mode, or a spray mode, and it is also possible to add various drawing effects such as blurring and gradation.

In relation thereto, there is known a graphic processor that displays a first cursor and a second cursor, and performs drawing on a screen based on drawing information specified by using the first cursor and a drawing on the screen, which is specified by using the second cursor, while switching cursors to be moved (see patent document 1 given below).

The following is a related art to the invention.

[Patent document 1] Japanese Patent Laid-Open Publication No. JP 09-190543

### SUMMARY

However, with the conventional drawing application, the user needs to move a pointer (cursor) frequently in order to, for example, select a desired drawing function, specify a drawing in a drawing area, or switch the drawing functions, which therefore tends to make the operation more complicated. One reason for this problem reside in that the user interface of the conventional drawing application is implemented by using one pointer. Also in the above-mentioned graphic processor that uses the first cursor and the second cursor, only the second cursor is used to specify a drawing, and the first cursor is used to specify the drawing information.

Further, when drawing is performed by actually using a hand instead of being performed on a computer, a drawing task may be performed by using both hands. Examples of such a case include a case where a user holds a paper pattern with one hand and sprays with the other hand, thereby drawing a pattern along the paper pattern. With the conventional drawing application, it has been impossible to realize such a drawing task that uses both hands.

The following configuration is adopted in respective aspects of the invention.

According to an aspect of the disclosures made herein, a drawing device includes a pointer control section detecting each of operations performed by using a first pointer and a second pointer in a drawing region; a first generating section generating first drawing data that corresponds to a first drawing function specified for the first pointer and an operation performed in the drawing region by using the first pointer; a second generating section generating second drawing data that corresponds to a second drawing function specified for the second pointer and an operation performed in the drawing region by using the second pointer; and a drawing section generating drawing data obtained by combining the first drawing data and the second drawing data.

Note that, as other aspects of the disclosures made herein, there may be provided a method and a program for realizing the above-mentioned configuration, a non-transitory computer readable storage medium having the program recorded thereon, and the like.

The objects and advantages of the invention will be realized and attained by means of the elements and combinations particularly pointed out in the claims.

### BRIEF DESCRIPTION OF THE DRAWINGS

FIG. 1 is a diagram illustrating a hardware configuration example of a drawing device according to a first embodiment;

FIG. 2 is a block diagram illustrating a processing configuration example of the drawing device according to the first embodiment;

FIG. 3 is a diagram illustrating an example of an operation screen;

FIG. 4 is a diagram illustrating an example of a drawing setting table;

FIG. 5 is a diagram illustrating a concept of drawing data generating processing;

FIG. 6 is a flow chart illustrating an operation example of the drawing device according to the first embodiment;

FIG. 7 is a diagram illustrating Drawing Example 1 in which the drawing device according to the first embodiment is used;

FIG. 8 is a diagram illustrating Drawing Example 2 in which the drawing device according to the first embodiment is used;

FIG. 9 is a diagram illustrating Drawing Example 3 in which the drawing device according to the first embodiment is used;

FIG. 10 is a diagram illustrating an example of a drawing setting table in a drawing device according to a modification example; and

FIG. 11 is a diagram illustrating a hardware configuration example of the drawing device according to the modification example.

### DESCRIPTION OF EMBODIMENTS

The embodiments of the disclosures made herein will be described below referring to the drawings in detail. The drawings illustrate preferred embodiments. It should be understood, however, that the embodiments can be implemented by many different embodiments, and are not limited to the embodiments described herein.

Hereinbelow, a drawing device according to a first embodiment is described.

[Device Configuration]

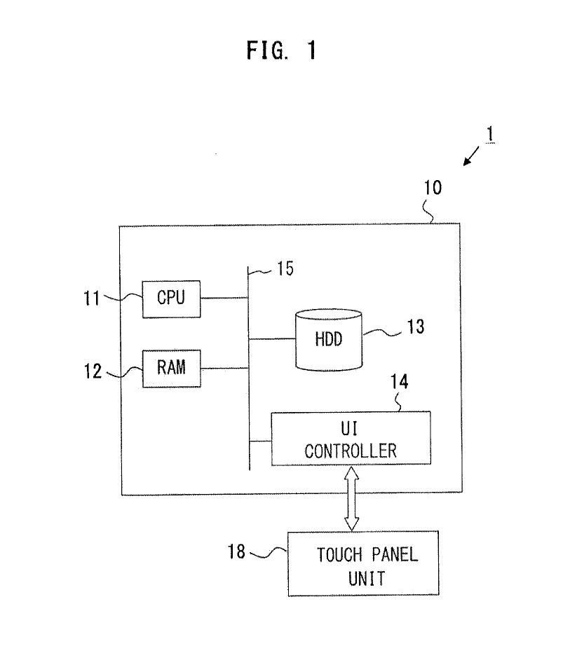

FIG. 1 is a diagram illustrating a hardware configuration example of the drawing device according to the first embodiment. A drawing device 1 according to the first embodiment includes, as a hardware configuration, a main body unit 10, a user interface unit, and the like. The main body unit 10 includes a CPU (central processing system) 11, a random access memory (RAM) 12, a hard disk drive (hereinafter, referred to as HDD) 13, a user interface controller (hereinafter, referred to as UI controller) 14, and the like . The CPU 11, the RAM 12, the HDD 13, and the UI controller 14 are connected to one another by a bus 15.

As the user interface unit according to the first embodiment, a touch panel unit 18 is employed. The drawing device 1 according to the first embodiment may be realized by a general-purpose computer such as a personal computer having such a hardware configuration, or may be realized by a dedicated computer. The embodiment imposes no limitation on the hardware configuration of the drawing device 1.

The touch panel unit 18 includes a display part, a touch panel that receives a user operation, a control part, and the like. The touch panel unit 18 causes the display part to display an image in accordance with drawing data sent from the main body unit 10, and receives an input from a user by sensing an external touch on the touch panel. The touch panel unit 18 sends the acquired input information to the main body unit 10.

The input information contains position information (coordinate information) corresponding to the position of a touch on the panel, operation information corresponding to a touch status, and the like. The operation information used herein contains information that enables identifying an operation in which a user touches the touch panel (hereinafter, referred to as touch operation), an operation in which the user releases the touch panel (hereinafter, referred to as release operation), an operation in which the user moves a location that the user is touching while keeping touching the panel (hereinafter, referred to as dragging operation), and the like. The position information and the operation information are generated by, for example, the control part of the touch panel unit 18.

The control part of the touch panel unit 18 refers to a signal indicating the position of a touch, which is sequentially output from the touch panel at predetermined intervals (sampling intervals or the like), and makes a determination on the above-mentioned operations based on this signal. When receiving a signal indicating contact, the control part detects occurrence of the touch operation. When the contact signal has not been received for a predetermined period of time after the detection of the touch operation, the control part detects occurrence of the release operation. Further, when the control part detects movement of the contact based on the contact signal, the control part determines that the operation is the dragging operation. Note that, the touch operation, the dragging operation, and the release operation may be determined on the main body unit 10 side. In this case, the touch panel unit 18 only needs to sequentially output a signal indicating the position of a touch to the main body unit 10 at predetermined intervals (sampling intervals or the like).

The touch panel unit 18 according to the first embodiment is also capable of sensing simultaneous contact at a plurality of different positions. For example, even when the user touches different positions on the touch panel with both hands of the user, the touch panel unit 18 senses the contacts at the respective positions, and sends pieces of input information that indicate the respective contacts to the main body unit 10. For example, when a plurality of pieces of input information are included among pieces of information received collectively, the main body unit 10 can determine that the simultaneous contact at a plurality of positions has occurred.

The UI controller 14, which is connected to the touch panel unit 18, transmits the drawing data to the touch panel unit 18, and receives the input information and the operation information from the touch panel unit 18. Note that, the embodiment imposes no limitation on the interface between the touch panel unit 18 and the main body unit 10.

The CPU 11 is one or a plurality of processors, and operates by using the RAM 12, a ROM (not shown), a peripheral circuit such as an interface circuit (not shown), the HDD 13, and the like.

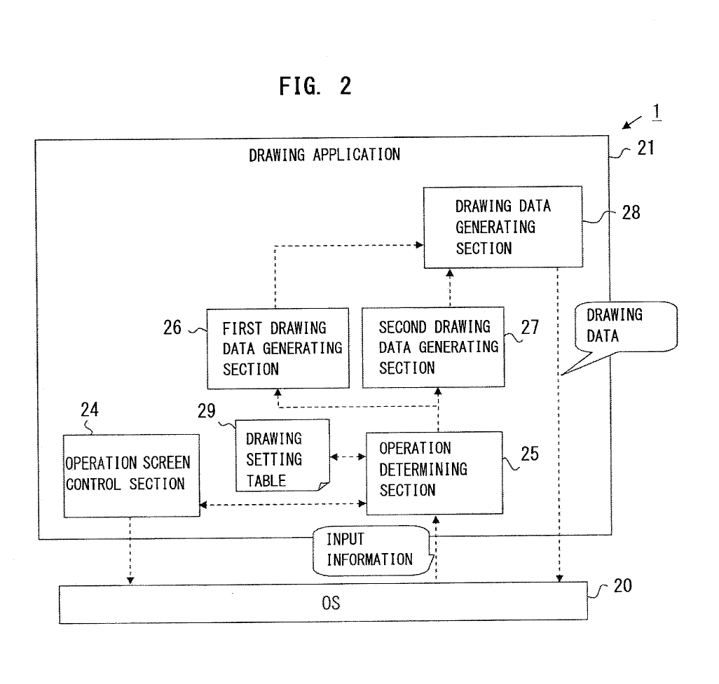

FIG. 2 is a block diagram illustrating a processing configuration example of the drawing device according to the first embodiment. The drawing device 1 according to the first embodiment includes an operation screen control section 24, an operation determining section 25, a first drawing data generating section (hereinafter, referred to as first generating section) 26, a second drawing data generating section (hereinafter, referred to as second generating section) 27, a drawing data generating section 28, and the like. Those processing sections may be implemented as hardware components or may be implemented as software components by executing a program stored in the HDD 13, the ROM (not shown), or the like by the CPU 11 (see the section “Others”).

FIG. 2 illustrates an example of the case where the processing sections are implemented as the software components. In this case, a program stored in the HDD 13, the ROM (not shown), or the like is executed by the CPU 11, thereby starting an operating system (OS) 20. The OS 20 controls input and output of the UI controller 14 and the like described above. While performing task management for various kinds of applications, the OS 20 operates as the interface between those applications and the UI controller 14 or the like.

Specifically, when a contact operation is sensed by the touch panel unit 18, the OS 20 receives the input information corresponding to the contact operation from the UI controller 14. The OS 20 notifies the respective applications, for which the OS 20 performs the task management, of the received input information. Further, when receiving a display instruction along with the drawing data from a drawing application 21, the OS 20 controls the UI controller 14 so as to cause the display part of the touch panel unit 18 to display an image corresponding to the drawing data.

The drawing application 21 is implemented by, under control of the OS 20, executing a program stored in the HDD 13, the ROM (not shown), or the like by the CPU 11. In the example of FIG. 2, the drawing application 21 implements, as the software components, the operation screen control section 24, the operation determining section 25, the first generating section 26, the second generating section 27, and the drawing data generating section 28. The drawing application 21 executes those processing sections, thereby enabling drawing in which two pointers (hereinafter, referred to as first pointer and second pointer) that are independently operable at the same time are used.

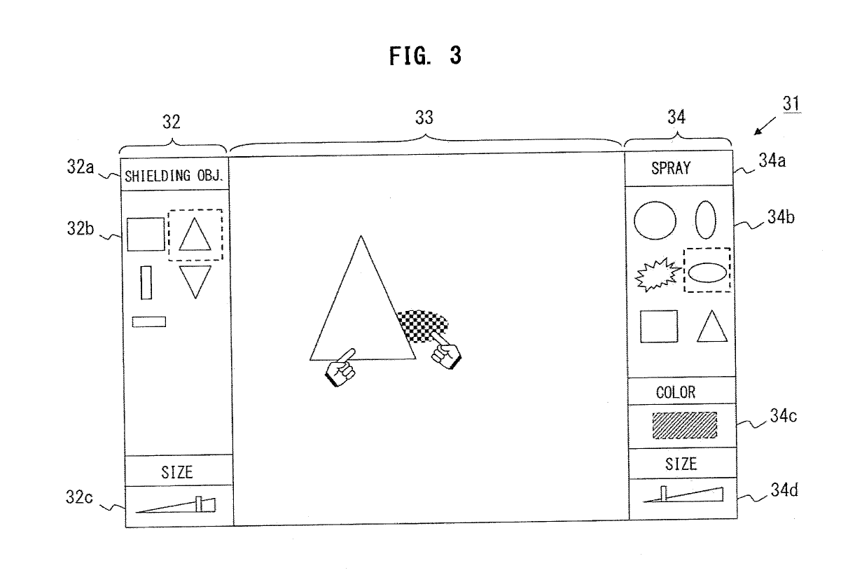

When the drawing application 21 is started, the operation screen control section 24 generates operation screen data, and causes the display part of the touch panel unit 18 to display the operation screen. FIG. 3 is a diagram illustrating an example of the operation screen. An operation screen 31 includes a first setting area 32, a drawing area 33, and a second setting area 34.

The drawing area 33 is an area for performing a drawing operation that uses the first pointer and the second pointer. The first pointer and the second pointer are pointers independently operable at the same time, and detailed description thereof is given later. The user performs the drawing operation by touching on the drawing area 33 of the operation screen 31 displayed on the touch panel unit 18. In the drawing operation for the drawing area 33, the first pointer and the second pointer may be provided with different drawing functions. For example, the first pointer may be assigned with a drawing function of a shielding object, and the second pointer may be assigned with a drawing function of a spray. Hereinafter, the drawing function assigned to the first pointer is referred to as first drawing function, and the drawing function assigned to the second pointer is referred to as second drawing function.

The first setting area 32 is an area for setting the first drawing function. The second setting area 34 is an area for setting the second drawing function. The first setting area 32 and the second setting area 34 include subareas 32a and 34a for setting the drawing functions, respectively.

In the subarea 32a for the first pointer, for example, any one of the shielding object, range specification, and a drawing type (pen, spray, and the like) is selectable. The first pointer is a pointer that is to be recognized by touching on the drawing area 33 prior to the second pointer, and hence it is desired that the drawing functions, such as the shielding object and the range specification, which are expected to be operated earlier, be selectable only in the subarea 34a for the first pointer. Accordingly, in the subarea 34a for the second pointer, for example, it is desired that any one of the drawing types be selectable. In the example of FIG. 3, the shielding object is selected in the subarea 32a for the first pointer, and the spray is selected in the subarea 34a for the second pointer.

After the drawing functions are respectively selected in the subareas 32a and 34a, subareas for performing detailed setting regarding the selected drawing functions are displayed in free areas of the first setting area 32 and the second setting area 34, respectively. As in the example of FIG. 3, for example, when the shielding object is selected in the subarea 32a, there are displayed a subarea 32b for selecting any one of a plurality of shapes selectable as the shielding object and a subarea 32c for setting the size of the shielding object. When the spray is selected in the subarea 34a, there are displayed a subarea 34b for selecting any one of a plurality of selectable spraying shapes, a subarea 34c for setting the color of the spray, and a subarea 34d for setting the size of the spraying. Further, when the range specification is selected as the drawing function, for example, a subarea for selecting an effect (gradation, blurring, masking, or the like) to be provided in the range is displayed.

The operation determining section 25 receives, via the OS 20, the input information sent in response to the contact operation performed on the touch panel unit 18, and then determines the user operation performed on the touch panel unit 18 based on the received input information. Specifically, when at least one of the touch operation, the release operation, and the dragging operation has been detected by the touch panel unit 18, the operation determining section 25 acquires the input information containing the operation information that enables identifying the operation and the position information for identifying the position of the operation.

When determining, based on the input information, that the operation has been performed in the first setting area 32 or the second setting area 34 of the operation screen 31, the operation determining section 25 acquires information regarding the drawing function selected by the user and the detailed settings thereof, based on the position information. The operation determining section 25 stores the acquired information in a drawing setting table. The drawing setting table is stored in, for example, the RAM 12.

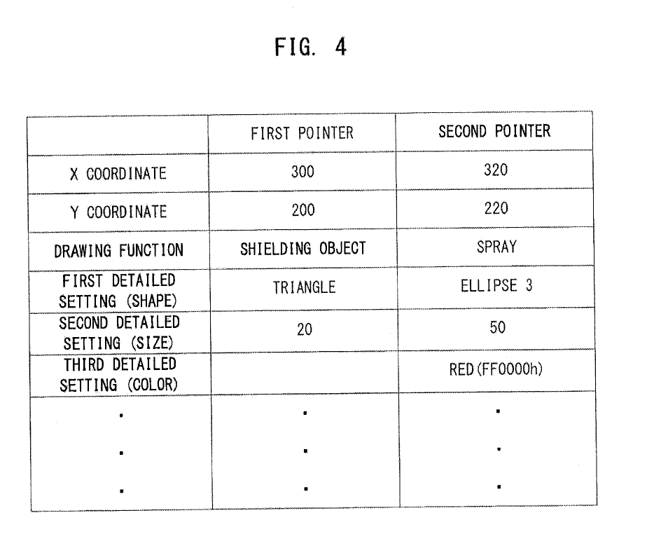

FIG. 4 is a diagram illustrating an example of the drawing setting table. The drawing setting table stores, regarding the first pointer and the second pointer, an X coordinate and a Y coordinate indicating the position of the pointer, the drawing function, the detailed settings, and the like. In each of the X coordinate field and the Y coordinate field, the position information contained in the input information is set. In the drawing function field for the first pointer, the first drawing function selected in the subarea 32a of the first setting area 32 is set. In the drawing function field for the second pointer, information indicating the second drawing function selected in the subarea 34a of the second setting area 34 is set.

The detailed setting field stores detailed setting information regarding the drawing function in accordance with the selected drawing function. As illustrated in the example of FIG. 4, examples of the detailed setting field include a first detailed setting field that relates to the shape, a second detailed setting field that relates to the size, and a third detailed setting field that relates to the color. In addition, a fourth detailed setting field that relates to the effect, such as gradation and blurring, may be included. Pieces of information selected in the subareas of the first setting area 32 and the second setting area 34 of the operation screen 31 are stored in the respective detailed setting fields.

When determining, based on the input information, that the operation has been performed in the drawing area 33 of the operation screen 31, the operation determining section 25 performs pointer control processing. In the pointer control processing, the operation determining section 25 determines whether or not the input information indicates a first touch to be performed in the drawing area 33. The first touch refers to a state in which a contact operation other than the contact in question has not been performed in the drawing area 33. Accordingly, when the touch operation or the dragging operation is not being operated at that time in the drawing area 33 except for the touch operation indicated by the input information, the operation determining section 25 determines that the touch operation indicated by the input information is the first touch. On the other hand, when the touch operation or the dragging operation is being operated at that time in the drawing area 33 in addition to the touch operation indicated by the input information, the operation determining section 25 determines that the touch operation indicated by the input information is a second touch.

When recognizing the operation of the first pointer, the operation determining section 25 sets the position information thereon in the X coordinate field and the Y coordinate field for the first pointer in the drawing setting table. When recognizing the operation of the second pointer, the operation determining section 25 sets the position information thereon in the X coordinate field and the Y coordinate field for the second pointer in the drawing setting table.

The operation determining section 25 displays the first pointer at a position (X coordinate and Y coordinate) where the touch operation determined to be the first touch has been performed, and recognizes the release operation and the dragging operation that follow the touch operation as the operation of the first pointer. Specifically, when the touch operation has been shifted to the dragging operation after the first pointer is displayed, the first pointer is moved to coordinates identified by the position information sequentially input in response to the dragging operation. In the same manner, the operation determining section 25 displays the second pointer at a position where the touch operation determined to be the second touch has been performed, and recognizes the release operation and the dragging operation that follow the touch operation as the operation of the second pointer.

With this, when the simultaneous contact at a plurality of different positions has been sensed in the drawing area 33, the first pointer and the second pointer are displayed simultaneously. When the touch operation regarding the second pointer has been shifted to the release operation after the second pointer is displayed, the operation determining section 25 erases the second pointer. When erasing the second pointer, the operation determining section 25 erases the respective pieces of data in the X coordinate field and the Y coordinate field for the second pointer in the drawing setting table. Further, when the touch operation regarding the first pointer has been shifted to the release operation after the first pointer and the second pointer are displayed, the operation determining section 25 erases both the first pointer and the second pointer. When erasing the first pointer, the operation determining section 25 erases the respective pieces of data in the X coordinate field and the Y coordinate field for the first pointer in the drawing setting table.

When recognizing the operation of the first pointer, the operation determining section 25 sends the operation information thereon and information regarding the first pointer in the drawing setting table to the first generating section 26. On the other hand, when recognizing the operation of the second pointer, the operation determining section 25 sends the operation information thereon and information regarding the second pointer in the drawing setting table to the second generating section 27.

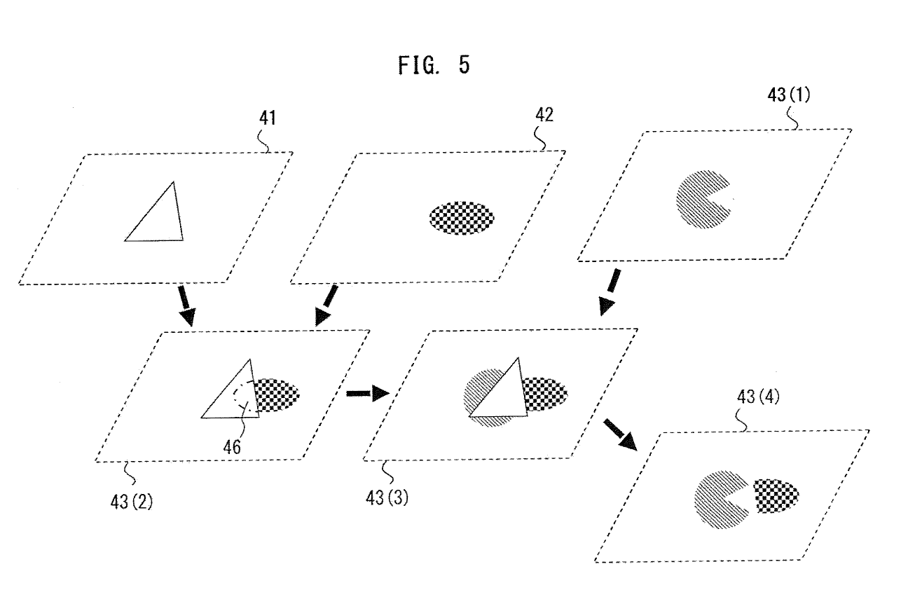

FIG. 5 is a diagram illustrating a concept of drawing data generating processing performed by the first generating section 26, the second generating section 27, and the drawing data generating section 28.

The drawing data generating section 28 generates the drawing data that is to be eventually displayed by the display part of the touch panel unit 18. The drawing data generating section 28 has a canvas 43 for the drawing data. The first generating section 26 and the second generating section 27 also have their own canvases 41 and 42. The canvases 41, 42, and 43 have the same size, and are stored in the RAM 12 as, for example, memory areas corresponding to the size.

The first generating section 26 generates, on the canvas 41, first drawing data including an image drawn through the drawing operation using the first pointer. The second generating section 27 generates, on the canvas 42, second drawing data including an image drawn through the drawing operation using the second pointer. In the example of FIG. 5, a triangular shielding object is assigned to the first drawing function, and spray drawing is assigned to the second drawing function. Accordingly, the drawing data in which the shielding object is drawn at the position specified by the first pointer is stored on the canvas 41, and the drawing data in which the spray drawing is performed at the position specified by the second pointer is stored on the canvas 42.

The drawing data generating section 28 generates, on the canvas 43, drawing data obtained by combining the drawing data on the canvas 41 and the drawing data on the canvas 42 (see reference symbol 43(2) of FIG. 5). With regard to a drawing portion 46 where the first drawing data and the second drawing data overlap each other, the drawing data generating section 28 applies a drawing effect corresponding to the first drawing function or the second drawing function. In the example of FIG. 5, a shielding effect corresponding to the shielding object specified as the first drawing function is applied to the drawing portion 46. When the range specification for blurring is set as the first drawing function, a blurring effect is applied to the drawing portion 46.

When there already exists drawing data stored on the canvas 43, the drawing data generating section 28 generates drawing data (reference symbol 43(3) of FIG. 5) obtained by overwriting the newly combined drawing data (reference symbol 43(2) of FIG. 5) onto the already existing drawing data (reference symbol 43(1) of FIG. 5). In the example of FIG. 5, the shielding object is specified as the first drawing function, and hence when the release operation has been detected regarding the first pointer, the first drawing data is erased with leaving the effect of the combining. The same applies also in the case where the range specification is specified as the first drawing function.

The drawing data generating section 28 sends the drawing data on the canvas 43 to the OS 20, to thereby cause the display part of the touch panel unit 18 to display the drawing data. Note that, the combining of the first drawing data and the second drawing data by the drawing data generating section 28 may be executed when any one of the first drawing data and the second drawing data has been updated, or may be executed at predetermined intervals. Further, through the action of the OS 20 or the like, the drawing data on the canvas 43 may be caused to be always displayed on the display part of the touch panel unit 18.

[Operation Example]

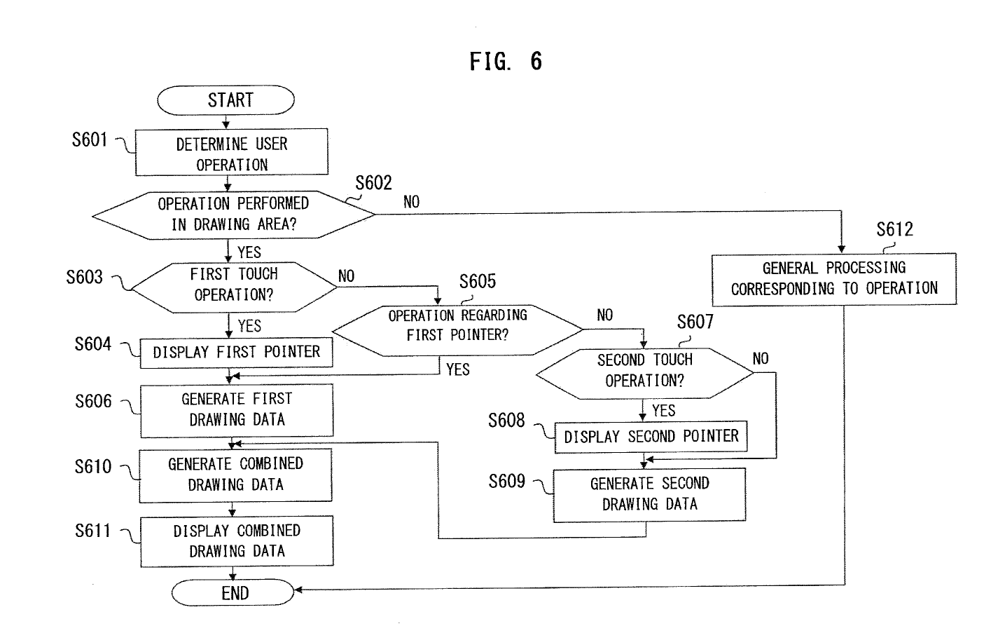

FIG. 6 is a flow chart illustrating an operation example of the drawing device 1 according to the first embodiment.

When the user touches the touch panel to operate the screen displayed on the touch panel unit 18, the touch panel unit 18 detects the contact operation. The touch panel unit 18 sends, to the main body unit 10, the input information containing the position information (coordinate information), the operation information corresponding to the touch status, and the like, which relates to the detected contact operation.

In the main body unit 10, when the UI controller 14 has acquired the input information, the acquisition of the input information is notified to the drawing application 21 via the OS 20. In the drawing application 21, the operation determining section 25 acquires the input information.

When acquiring the input information, the operation determining section 25 determines the user operation that corresponds to the input information (S601). Based on the position information contained in the input information, the operation determining section 25 determines whether or not the user operation is an operation performed in the drawing area 33 of the operation screen 31 (S602). When the operation determining section 25 determines that the user operation is not an operation performed in the drawing area 33 (S602; NO), the operation determining section 25 performs general processing corresponding to the operation (S612).

The general operation includes operations performed in the first setting area 32 and the second setting area 34 of the operation screen 31. When the user operation is a setting operation performed in the first setting area 32, the drawing function corresponding to the setting operation is set as the first drawing function in the drawing setting table. When the user operation is a setting operation performed in the second setting area 34, the drawing function corresponding to the setting operation is set as the second drawing function in the drawing setting table. Note that, initial values may respectively be set as the first drawing function and the second drawing function in the drawing setting table.

When the operation determining section 25 determines that the user operation is an operation performed in the drawing area 33 (S602; YES), the operation determining section 25 determines whether or not the user operation is a first touch operation (S603). Specifically, the operation determining section 25 determines that the user operation is the first touch operation when the operation information contained in the input information indicates the touch operation and, except for that touch operation, the touch operation or the dragging operation is not being performed at that time in the drawing area 33.

When the operation determining section 25 determines that the user operation is the first touch operation (S603; YES), the operation determining section 25 displays the first pointer at a position identified by the position information contained in the input information (S604). Subsequently, the operation determining section 25 sends drawing information regarding the first pointer and the operation information thereon to the first generating section 26. The drawing information regarding the first pointer contains the information (X coordinate and Y coordinate) indicating the position of the first pointer, and information regarding the drawing function, the shape, the size, the color, and the like, which is specified as the first drawing function.

On the other hand, when the operation determining section 25 determines that the user operation is not the first touch operation (S603; NO), the operation determining section 25 determines whether or not the user operation is a user operation regarding the first pointer (S605). In this case, the user operation regarding the first pointer corresponds to the dragging operation or the release operation, which follows the first touch state. When the operation determining section 25 determines that the user operation is a user operation regarding the first pointer (S605; YES), the operation determining section 25 sends the drawing information regarding the first pointer and the operation information thereon to the first generating section 26.

When acquiring the drawing information and the operation information regarding the first pointer from the operation determining section 25, the first generating section 26 generates the first drawing data based on those pieces of information on the canvas 41 (S606).

When the operation determining section 25 determines that the user operation is not the first touch operation (S603; NO) and is not a user operation regarding the first pointer (S605; NO), the operation determining section 25 determines whether or not the user operation corresponds to a second touch operation (S607). Specifically, the operation determining section 25 determines that the user operation is the second touch operation when the operation information contained in the input information indicates the touch operation and the touch operation or the dragging operation is being performed at that time in the drawing area 33 in addition to that touch operation. A determination regarding whether or not the touch operation or the dragging operation is being performed in the drawing area 33 in addition to that touch operation may be implemented by, for example, determining whether or not the input information contains a plurality of pieces of operation information, or determining whether or not the first pointer is already displayed.

When the operation determining section 25 determines that the user operation is the second touch operation (S607; YES), the operation determining section 25 displays the second pointer at a position identified by the position information contained in the input information (S608). Subsequently, the operation determining section 25 sends the drawing information regarding the second pointer and the operation information thereon to the second generating section 27. The drawing information regarding the second pointer contains the information (X coordinate and Y coordinate) indicating the position of the second pointer, and information regarding the drawing function, the shape, the size, the color, and the like, which is specified as the second drawing function.

On the other hand, when the operation determining section 25 determines that the user operation is not the second touch operation (S607; NO), the operation determining section 25 sends the drawing information regarding the second pointer and the operation information thereon to the second generating section 27. Here, when it is determined by the operation determining section 25 that the user operation is not the second touch operation, the user operation is a user operation regarding the second pointer. Specifically, the user operation corresponds to the dragging operation or the release operation that follows the second touch and uses the second pointer.

When acquiring the drawing information and the operation information regarding the second pointer from the operation determining section 25, the second generating section 27 generates the second drawing data based on those pieces of information on the canvas 42 (S609).

The drawing data generating section 28 generates combined drawing data obtained by combining the first drawing data generated by the first generating section 26 and the second drawing data generated by the second generating section 27 (S610). In creating the combined drawing data, the drawing data generating section 28 provides the drawing effect corresponding to the first drawing function or the second drawing function to the drawing portion in which the first drawing data and the second drawing data overlap each other. The combined drawing data generated by the drawing data generating section 28 is sent to the touch panel unit 18 via the OS 20 and the UI controller 14. As a result, a screen corresponding to the combined drawing data is displayed on the display part of the touch panel unit 18 (S611).

<Drawing Example>

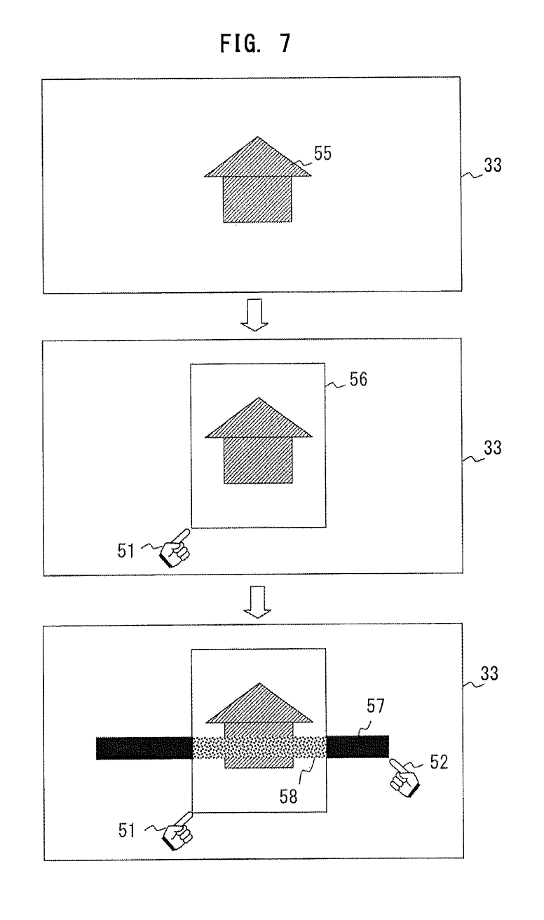

Hereinbelow, description is given of a specific example of drawing that uses the drawing device according to the first embodiment with reference to FIGS. 7, 8, and 9.

FIG. 7 is a diagram illustrating Drawing Example 1 by the drawing device according to the first embodiment. The example of FIG. 7 illustrates a state in which a graphic 55 is already drawn in the drawing area 33 of the operation screen 31.

The user selects the range specification as the first drawing function in the subarea 32a of the first setting area 32 of the operation screen 31. After the drawing function of the range specification is selected in the subarea 32a, a selection screen for the shape of the range specification is displayed in the subarea 32b, and a selection screen for the effect in the range is displayed in the subarea 32c. Here, it is assumed that a quadrangle is selected as the shape of the range specification, and that blurring is selected as the effect in the range.

Further, the user selects a pen in the drawing type as the second drawing function in the subarea 34a of the second setting area 34 of the operation screen 31. After the drawing function of the pen is selected in the subarea 34a, a selection screen for the thickness of the pen is displayed in the subarea 34b, and a selection screen for the color of the pen is displayed in the subarea 34c. With this, a given thickness is selected, and a given color is selected. Hereinbelow, a case where the user uses a finger of the user for operating the touch panel is taken as an example. It is to be noted that the touch panel may be operated by using such an object as a stylus pen.

The user makes a touch in the drawing area 33 of the operation screen 31 displayed by the touch panel unit 18 with a finger of one hand. This operation is determined to be the first touch operation by the drawing device 1, and a first pointer 51 is displayed on the touch panel unit 18. Subsequently, the first pointer 51 moves while following the movement of the touching finger.

The user specifies a range 56 by sliding the touching finger (first pointer 51). The range specification and the detailed settings thereof, which are specified as the first drawing function, are reflected to the range 56. At that time, the first generating section 26 of the drawing device 1 draws an image indicating the specified range 56 on the canvas 41 of its own.

With the above-mentioned finger kept touching the touch panel, the user makes a touch at a given position in the drawing area 33 of the operation screen 31 on the touch panel with a finger of another hand. This operation is determined to be the second touch operation by the drawing device 1, and a second pointer 52 is displayed on the touch panel unit 18. Subsequently, the second pointer 52 moves while following the movement of the finger that has performed the second touch operation.

The user performs the drawing that uses the pen by sliding the finger (second pointer 52) that has performed the second touch operation. The pen drawing function and the detailed settings thereof, which are specified as the second drawing function, are reflected to a pen image 57 to be drawn through the pen drawing. At that time, the second generating section 27 of the drawing device 1 draws the pen image 57 on the canvas 42 of its own.

In the drawing device 1, the drawing data generating section 28 generates the combined drawing data based on the range 56 drawn by the first pointer 51 and the pen image 57 drawn by the second pointer 52, and then causes the touch panel unit 18 to display the combined drawing data. In this case, as illustrated in the example of FIG. 7, part of the pen image 57 is included in the range 56. The drawing data generating section 28 provides the blurring effect as an attribute of the range specification to a portion 58 of the pen image 57 included in the range 56 drawn by the first pointer 51.

After that, when the finger corresponding to the second pointer is released from the touch panel, the second pointer 52 is erased, and also, the pen image 57 is confirmed. Subsequently, when the finger corresponding to the first pointer is released from the touch panel, the first pointer 51 is erased, and also, the image indicating the range 56 disappears.

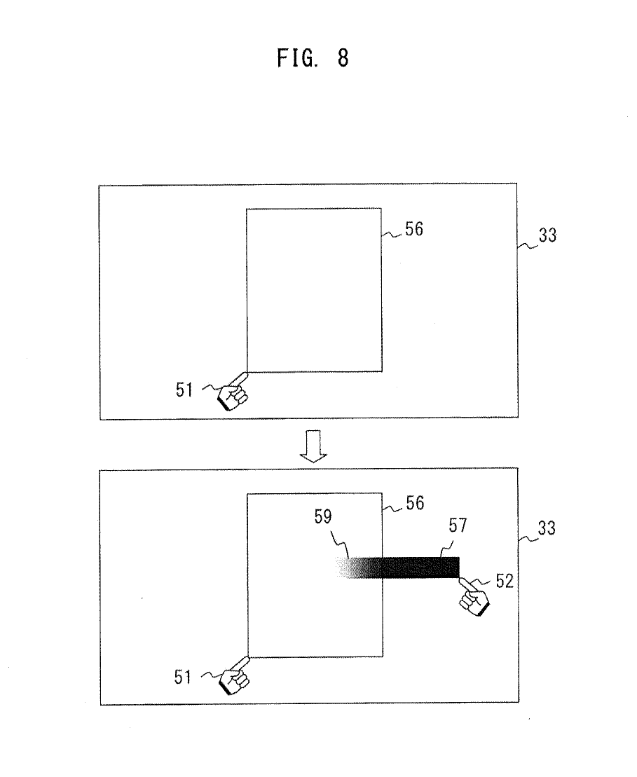

FIG. 8 is a diagram illustrating Drawing Example 2 in which the drawing device according to the first embodiment is used. In the example of FIG. 8, the range specification is selected as the first drawing function, the quadrangle is selected as the shape of the range specification, and the gradation is selected as the effect in the range. The pen is specified as the second drawing function, and a given thickness and a given color are respectively selected.

In the example of FIG. 8, a gradation effect as an attribute of the range specification is provided to a portion 59 of the pen image 57 included in the range 56 drawn by the first pointer 51.

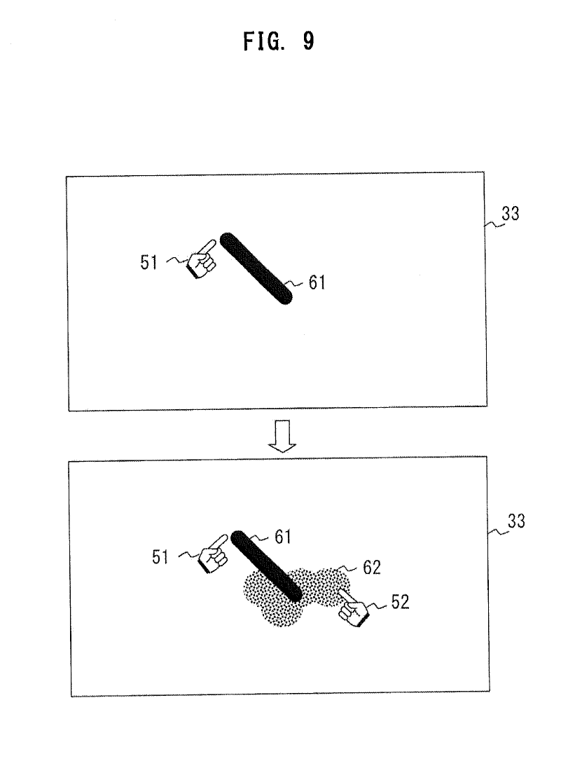

FIG. 9 is a diagram illustrating Drawing Example 3 in which the drawing device according to the first embodiment is used. FIG. 9 illustrates an example in which the drawing type is selected for each of the first drawing function and the second drawing function. Specifically, the pen is selected as the first drawing function, and the spray is selected as the second drawing function.

A pen image 61 is created by using the first pointer 51, and a spray image 62 is created by using the second pointer 52. In the example of FIG. 9, the pen image 61 is prioritized in a portion in which the pen image 61 and the spray image 62 overlap each other. As a result, the spray image 62 is overwritten with the pen image 61.

[Action and Effect of First Embodiment]

As described above, according to the drawing device 1 of the first embodiment, the first pointer and the second pointer are displayed simultaneously in accordance with a plurality of contact operations performed independently on the touch panel unit 18. It is possible to specify different drawing functions for the first pointer and the second pointer as the first drawing function and the second drawing function, respectively, and pieces of information regarding the respective drawing functions are stored in the drawing setting table.

Eventually, pieces of drawing data corresponding to the first drawing function and the second drawing function are respectively generated through the drawing operations that use the first pointer and the second pointer in the drawing area 33, and the combined drawing data obtained by combining those pieces of drawing data is displayed on the touch panel unit 18.

Accordingly, the user who uses the drawing device 1 according to the first embodiment can perform the drawing through an operation similar to that of actually performing the drawing by using both hands. Therefore, it is possible to realize, through an easy operation, spray art in which the user holds a paper pattern with one hand and uses a spray with the other hand. According to the first embodiment, the drawing can be performed using both hands, and hence operability in the drawing is enhanced compared to the conventional art.

In addition, different drawing functions can be set for the first pointer and the second pointer, and hence it is possible to provide drawing functions that accommodate various demands form users.

[Modification Example]

In the drawing device 1 according to the first embodiment described above, as in the example of FIG. 9, when the drawing type is specified for each of the first drawing function and the second drawing function, the first drawing function is prioritized, with the result that the second drawing data is overwritten with the first drawing data. A selection may be allowed between the first drawing function and the second drawing function to set the drawing function that is to be prioritized.

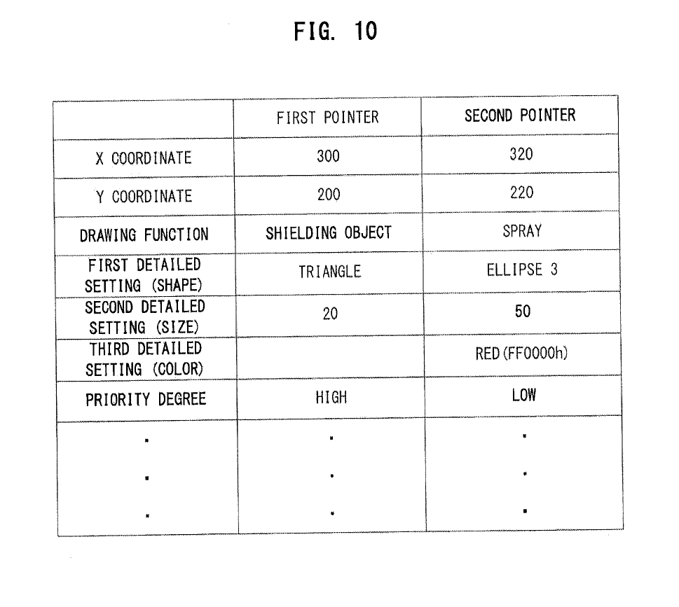

FIG. 10 is a diagram illustrating an example of a drawing setting table according to the modification example. As in the example of FIG. 10, a priority field may be added to the drawing setting table so as to store priority degrees regarding the first drawing function and the second drawing function. In the priority field of the drawing setting table, there is stored priority information selected in each subarea of the first setting area 32 and the second setting area 34 of the operation screen 31.

In the modification example, when the drawing type is specified for each of the first drawing function and the second drawing function, the drawing data generating section 28 only needs to preferentially adopt the drawing function having higher priority based on the priority information stored in the drawing setting table. The preferential adoption refers to, for example, overwriting.

Further, the drawing device 1 according to the first embodiment described above is provided with the touch panel unit 18, and the user operation is performed by using the touch panel unit 18. The drawing device 1 may be provided with other user operation input means than the touch panel unit 18.

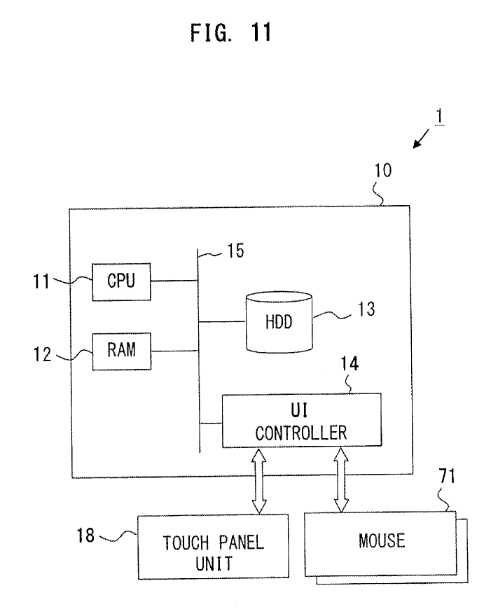

FIG. 11 is a diagram illustrating a hardware configuration example of the drawing device according to the modification example. An example of the above-mentioned user operation input means is a mouse. In the modification example, the touch panel unit 18 and a mouse 71 may be connected to the UI controller 14, or at least two mice 71 may be connected thereto instead of the touch panel unit 18.

In the case where two mice 71 are connected, a first pointer and a second pointer corresponding to mice 71(1) and 71(2), respectively, are displayed in advance by the OS 20. An operation determining section 25 according to the modification example does not need to determine whether the operation is the first touch operation or the second touch operation. It is only necessary that the first generating section 26 generate an image drawn by the mouse 71(1) corresponding to the first pointer, and that the second generating section 27 generate an image drawn by the mouse 71(2) corresponding to the second pointer.

In the case where the touch panel unit 18 and the mouse 71 are used in combination, a pointer corresponding to the mouse 71 is displayed by the OS 20. The operation determining section 25 according to the modification example may determine that the pointer corresponding to the mouse 71 is the first pointer when the pointer corresponding to the mouse 71 has been moved into the drawing area 33 under a state in which the contact operation is not performed in the drawing area 33 of the operation screen 31. In this case, when an operation has been performed in the drawing area 33 via the touch panel under a state in which the pointer corresponding to the mouse 71 is displayed in the drawing area 33, that contact operation is determined to be the second touch operation. Conversely, when an operation has been performed in the drawing area 33 via the touch panel under a state in which the pointer corresponding to the mouse 71 is not displayed in the drawing area 33, that contact operation is determined to be the first touch operation. Processing other than the determination processing for the first pointer and the second pointer may be the same as in the first embodiment.

According to the embodiments described above, it is possible to provide the drawing technology that enables enhancing operability in drawing.

[Others]

<Regarding Hardware Component and Software Component>

The hardware component refers to a hardware circuit, and is, for example, a field-programmable gate array (FPGA), an application-specific integrated circuit (ASIC), a gate array, a combination of logic gates, a signal processing circuit, an analog circuit, or the like.

The software component refers to a module (segment) for implementing the above-mentioned processing as software, and is not a concept for limiting the language, the development environment, or the like for implementing the software. Examples of the software component include a task, a process, a thread, a driver, firmware, a database, a table, a function, a procedure, a subroutine, a given portion of a program code, data structure, an array, a variable, and a parameter. Those software components are realized on one or a plurality of memories (one or a plurality of processors (for example, central processing unit (CPU), digital signal processor (DSP), or the like)).

Note that, the embodiments described above impose no limitation on a method for implementing the above-mentioned processing sections. The above-mentioned processing sections only need to be configured, as the above-mentioned hardware components or software components or a combination thereof, through a method implementable for a person having ordinary skill in this technical field.

What is claimed is:

1. A drawing device, comprising:
a pointer control section detecting each of operations performed by using a first pointer and a second pointer in a drawing region;
a first generating section generating first drawing data that corresponds to a first drawing function specified for the first pointer and an operation performed in the drawing region by using the first pointer;
a second generating section generating second drawing data that corresponds to a second drawing function specified for the second pointer and an operation performed in the drawing region by using the second pointer; and
a drawing section generating drawing data obtained by combining the first drawing data and the second drawing data.

2. The drawing device according to claim 1, wherein the drawing section generates the drawing data in which a drawing effect corresponding to the first drawing function or the second drawing function is provided to a drawing portion in which the first drawing data and the second drawing data overlap each other.

3. The drawing device according to claim 1, wherein, under a state in which the first pointer is displayed in the drawing region, when a predetermined operation performed with respect to a position different from a position at which the first pointer is displayed in the drawing region is detected, the pointer control section controls displaying of the second pointer.

4. The drawing device according to claim 1, further comprising a screen data generating section generating data of a drawing operation screen that includes the drawing region, a first setting region for specifying the first drawing function, and a second setting region for specifying the second drawing function,
wherein the first generating section acquires a drawing function specified in the first setting region as the first drawing function, and
the second generating section acquires a drawing function specified in the second setting region as the second drawing function.

5. The drawing device according to claim 1, wherein the drawing section is configured to:
acquire, when the first drawing data and the second drawing data are combined, priority information indicating which one of the first drawing function and the second drawing function is to be prioritized; and
preferentially employ a drawing function indicated by the priority information for a drawing portion in which the first drawing data and the second drawing data overlap each other.

6. The drawing device according to claim 1, wherein the first generating section generates first image data that contains a shield image when the first drawing function is shielding,
the second generating section generates second image data that contains a drawing image drawn by operating the second pointer when the second drawing function is drawing, and
the drawing section draws an image obtained by deleting, from the drawing image contained in the second image data, a portion that overlaps the shield image contained in the first image data.

7. The drawing device according to claim 1, wherein the first generating section generates first image data that contains an image indicating a specified range corresponding to an operation of the first pointer when the first drawing function is range specification for providing a predetermined effect,
the second generating section generates second image data that contains a drawing image drawn by operating the second pointer when the second drawing function is drawing, and
the drawing section draws an image in which the predetermined effect is added to a portion of the drawing image contained in the second image data, which is included in the specified range contained in the first image data.

8. A drawing method by which a computer executes processing comprising:
detecting each of operations performed by using a first pointer and a second pointer in a drawing region;
generating first drawing data that corresponds to a first drawing function specified for the first pointer and an operation performed in the drawing region by using the first pointer;
generating second drawing data that corresponds to a second drawing function specified for the second pointer and an operation performed in the drawing region by using the second pointer; and
generating drawing data obtained by combining the first drawing data and the second drawing data.

9. A non-transitory computer readable storage medium storing a program including a process to be executed by a computer, the process comprising:
detecting each of operations performed by using a first pointer and a second pointer in a drawing region;
generating first drawing data that corresponds to a first drawing function specified for the first pointer and an operation performed in the drawing region by using the first pointer;
generating second drawing data that corresponds to a second drawing function specified for the second pointer and an operation performed in the drawing region by using the second pointer; and
generating drawing data obtained by combining the first drawing data and the second drawing data.

10. The non-transitory computer readable storage medium according to claim 9, the process further comprising:
generating the drawing data in which a drawing effect corresponding to the first drawing function or the second drawing function is provided to a drawing portion in which the first drawing data and the second drawing data overlap each other.

11. The non-transitory computer readable storage medium according to claim 9, the process further comprising:
controlling displaying of the second pointer, under a state in which the first pointer is displayed in the drawing region, when a predetermined operation performed with respect to a position different from a position at which the first pointer is displayed in the drawing region is detected.

12. The non-transitory computer readable storage medium according to claim 9, the process further comprising:
generating data of a drawing operation screen that includes the drawing region, a first setting region for specifying the first drawing function, and a second setting region for specifying the second drawing function,
acquiring a drawing function specified in the first setting region as the first drawing function, and
acquiring a drawing function specified in the second setting region as the second drawing function.

13. The non-transitory computer readable storage medium according to claim 9, the process further comprising:
acquiring, when the first drawing data and the second drawing data are combined, priority information indicating which one of the first drawing function and the second drawing function is to be prioritized; and
preferentially employing a drawing function indicated by the priority information for a drawing portion in which the first drawing data and the second drawing data overlap each other.

14. The non-transitory computer readable storage medium according to claim 9, the process further comprising:
generating first image data that contains a shield image when the first drawing function is shielding,
generating second image data that contains a drawing image drawn by operating the second pointer when the second drawing function is drawing, and
drawing an image obtained by deleting, from the drawing image contained in the second image data, a portion that overlaps the shield image contained in the first image data.

15. The non-transitory computer readable storage medium according to claim 9, the process further comprising:
generating first image data that contains an image indicating a specified range corresponding to an operation of the first pointer when the first drawing function is range specification for providing a predetermined effect,
generating second image data that contains a drawing image drawn by operating the second pointer when the second drawing function is drawing, and
drawing an image in which the predetermined effect is added to a portion of the drawing image contained in the second image data, which is included in the specified range contained in the first image data.
